(19) United States
(12) Patent Application Publication
(10) Pub. No.: US 2014/0168581 A1
(43) Pub. Date: Jun. 19, 2014

(54) LCD PANEL, ELECTRONIC DEVICE, AND METHOD FOR PRODUCING LCD PANEL

(71) Applicants: Hisashi Watanabe, Osaka-shi (JP); Akira Sakai, Osaka-shi (JP); Yuichi Iyama, Osaka-shi (JP); Akiko Miyazaki, Osaka-shi (JP); Eiji Satoh, Osaka-shi (JP); Yasushi Asaoka, Osaka-shi (JP)

(72) Inventors: Hisashi Watanabe, Osaka-shi (JP); Akira Sakai, Osaka-shi (JP); Yuichi Iyama, Osaka-shi (JP); Akiko Miyazaki, Osaka-shi (JP); Eiji Satoh, Osaka-shi (JP); Yasushi Asaoka, Osaka-shi (JP)

(73) Assignee: SHARP KABUSHIKI KAISHA, Osaka-shi, Osaka (JP)

(21) Appl. No.: 14/236,128

(22) PCT Filed: Jul. 25, 2012
(86) PCT No.: PCT/JP2012/068843

§ 371 Date: Jan. 30, 2014

(30) Foreign Application Priority Data
Aug. 2, 2011 (JP) 2011-169565

(51) Int. Cl. G02F 1/1339

(52) U.S. Cl. CPC G02F 1/1339; G02F 1/13394
USPC 349/96; 349/156; 349/153; 445/25

(57) ABSTRACT

A liquid crystal display panel (100A) is a liquid crystal display panel having a displaying region (81) including a plurality of pixel regions (31), including: a liquid crystal layer (1) having a plurality of liquid crystal regions (11) containing a nematic liquid crystal material and polymer-containing walls (12) between adjacent ones of the plurality of liquid crystal regions (11); and a first substrate (2) and a second substrate (3) having the liquid crystal layer (1) retained therebetween. The liquid crystal layer (1) extends to at least one side face of the liquid crystal display panel (100A). The distance between at least one side face of the second substrate (3) and a pixel region (11) that is located at the outermost edge among the plurality of pixel regions (11) while being adjacent to the at least one side face is less than 0.2 mm.

### TECHNICAL FIELD

The present invention relates to a liquid crystal display panel, an electronic device, and a production method for a liquid crystal display panel.

### BACKGROUND ART

liquid crystal display devices have advantages such as light weight, thinness, and low power consumption, and are utilized not only for large-size television sets but also as small-sized display devices, e.g., display sections of mobile phones.

A liquid crystal display device includes a liquid crystal display panel, a backlight device, circuitry and a power supply for supplying various electrical signals to the liquid crystal display panel, and a housing which accommodates these. The liquid crystal display panel has a displaying region in which a plurality of pixels are arrayed, and a frame region around it.

The displaying region (active area) of a generic liquid crystal display device includes pixel electrodes, thin film transistors (TFTs), and the like provided therein, in which images, videos, or the like are displayed. In the frame region are provided: a sealing portion at which substrates are attached together so that a liquid crystal material is sealed in between the substrates; connection lines connected to the gate electrodes and source electrodes of the TFTs; terminals for connection with external driving circuits which input signal/scanning voltages; and so on. In the present specification, any region in which connection lines to the gate electrodes and source electrodes of TFTs, terminals for connection with external driving circuits which input signal/scanning voltages, and the like are located may be referred to as a connection region. In order to prevent deteriorations in display quality at the outer periphery of the active area due to leakage of light from the backlight, disorderly alignment of liquid crystal molecules, and so on, a black mask (light-shielding member) is usually provided in the frame region. Thus, the frame region is a region not contributing to displaying (invalid displaying portion). While liquid crystal display devices are becoming narrower and narrower in their frames each year, it is difficult to eliminate the frame region.

Now, limitations as to how narrow a frame region 81a of a generic liquid crystal display panel (e.g., a TN (Twisted Nematic) type liquid crystal panel) 500 can be will be described with reference to FIG. 12(a) and FIG. 12(b). FIG. 12(a) is a schematic plan view of the liquid crystal display panel 500, and FIG. 12(b) is a schematic cross-sectional view of an a portion shown in FIG. 12(a).

The liquid crystal display panel 500 has a displaying region 81 and a frame region 81a located at the periphery of the displaying region 81. A plurality of pixel electrodes 4 are formed in the displaying region 81 of the liquid crystal display panel 500. The frame region 81a is a region which does not contribute to displaying. In the frame region 81a of the liquid crystal display panel 500, a sealing portion 99 is formed so as to surround the liquid crystal layer 1. The width Ds of the frame region 81a is expressed as a sum of the width D1 of the sealing portion 99 and the distance D2 between the sealing portion 99 and a pixel electrode 4 which is adjacent to the sealing portion 99. The sealing portion 99 is formed by using a dispenser apparatus, a screen printer, or the like to apply a sealant on a substrate so as to constitute a predetermined pattern, and, after this is attached to the other substrate, curing the sealant. The final width D1 of the sealing portion 99 is about 1 mm or more.

Patent Document 1 discloses a method in which a pair of substrates are attached together via a sealant that is applied so as to constitute a predetermined pattern, and thereafter the substrates are cut up, together with the sealant, to thereby produce a plurality of liquid crystal display panels. In the disclosed method, the width D1 of the sealing portion 99 is made about 1 mm or less. According to the method disclosed in Patent Document 1, although the width of the sealing portion 99 can be made about 1 mm or less, making the width D1 of the sealing portion 99 too thin would result in an inadequate strength which induces an insufficiency in that the sealing portion 99 may peel off under a high temperature and high humidity. The above insufficiency will become especially outstanding when the width D1 of the sealing portion 99 is about 0.5 mm or less, and thus the sealing portion 99 of the liquid crystal display panel which is currently mass-produced by the Applicants has a width greater than 0.5 mm.

Next, the reason why it is difficult for the frame region 81a of the liquid crystal display panel 500 to have a width Ds of about 0.5 mm or less will be described.

In the liquid crystal display panel 500, the distance D2 which is needed to maintain the alignment of the liquid crystal material contained in the liquid crystal layer 1 is about 0.2 mm or more. When the distance D2 is less than about 0.2 mm, the liquid crystal material alignment will become disorderly due to the influence of the sealing portion 99, thus causing poor displaying such as a lowered contrast ratio. This means that, in order for the frame region 81a to have a width Ds of about 0.5 mm or less, the width D1 of the sealing portion 99 needs to be about 0.3 mm or less. On the other hand, if the width D1 of the sealing portion 99 is about 0.1 mm or less, the sealing portion 99 will peel off due to inadequate strength, thus causing poor displaying. When the precision of a dispenser apparatus used for forming the sealing portion 99 is taken into consideration, it is very difficult to control the width D1 of the sealing portion 99 to about 0.2 mm to 0.3 mm with a good production yield.

On the other hand, Patent Document 2 discloses a liquid crystal display device having a polymer dispersed liquid crystal (PDLC) layer in which a curable vinyl compound is used. Patent Document 2 states that forming a polymer dispersed liquid crystal layer from a curable vinyl compound provides an effect of adhesively bonding the pair of substrates, without even forming the sealing portion 99 which would belong to the liquid crystal display panel 500.

### CITATION LIST

### Patent Literature

[Patent Document 1] Japanese Patent No. 3389461
[Patent Document 2] Japanese Patent No. 2550627

### SUMMARY OF INVENTION

### Technical Problem

However, although Patent Document 2 states that there is no need to form a sealing portion, it does not disclose a production method for a liquid crystal display device which lacks a sealing portion.

The present invention has been made in view of the above problems, and an objective thereof is to provide a liquid crystal display panel which is suitable for a narrowed frame region and which has a good mass production efficiency, as well as a production method for such a liquid crystal display panel.

### Solution to Problem

A liquid crystal display panel according to an embodiment of the present invention is a liquid crystal display panel having a displaying region including a plurality of pixel regions, the liquid crystal display panel comprising: a liquid crystal layer having a plurality of liquid crystal regions containing a nematic liquid crystal material and polymer-containing walls between adjacent ones of the plurality of liquid crystal regions; and a first substrate and a second substrate having the liquid crystal layer retained therebetween, wherein, the liquid crystal layer extends to at least one side face of the liquid crystal display panel; and a distance between at least one side face of the second substrate and a pixel region that is located at an outermost edge among the plurality of pixel regions while being adjacent to the at least one side face is less than 0.2 mm.

In one embodiment, the above liquid crystal display panel further comprises: a first alignment film and a second alignment film respectively formed between the liquid crystal layer and the first substrate and the second substrate so as to be each in contact with the liquid crystal layer; and polarizers respectively provided on sides of the first substrate and the second substrate opposite from the liquid crystal layer.

In one embodiment, the nematic liquid crystal material has positive dielectric anisotropy; at least one of the first alignment film and the second alignment film is a horizontal alignment film; the horizontal alignment film has been subjected to an alignment treatment; and in the plurality of liquid crystal regions, in the absence of applied voltage, an in-plane azimuth of liquid crystal molecules at an interface with the horizontal alignment film which has been subjected to an alignment treatment is parallel to an azimuth defined by the alignment treatment.

In one embodiment, the nematic liquid crystal material has positive dielectric anisotropy; and the first alignment film and the second alignment film are vertical alignment films.

In one embodiment, an alignment state of the nematic liquid crystal material is controlled with a lateral electric field.

In one embodiment, the above liquid crystal display panel includes two liquid crystal regions such that, in the absence of applied voltage, an azimuth of tilt of liquid crystal molecules at an interface with the first alignment film differs from an azimuth of tilt of liquid crystal molecules at an interface with the second alignment film.

In one embodiment, the above liquid crystal display panel further comprises λ/4 plates provided between the first substrate and the polarizer and between the second substrate and the polarizer.

In one embodiment, the above liquid crystal display panel has a connection region to be electrically connected to an external circuit, and has a sealing portion that adhesively bonds the first substrate and the second substrate, the sealing portion being between the connection region and the displaying region.

In one embodiment, the above liquid crystal display panel has a driving circuit provided outside the displaying region, and has the sealing portion between the driving circuit and the displaying region.

In one embodiment, when viewed from a normal direction of the liquid crystal display panel, at least one or more of side faces of the liquid crystal layer are level with a side face of the first substrate and a side face of the second substrate.

In one embodiment, the above liquid crystal display panel further comprises a side-face sealing resin portion formed so as to be in contact with the side face of the liquid crystal layer and the side face of the first substrate and the side face of the second substrate.

An electronic device according to an embodiment of the present invention comprises first and second liquid crystal display panels, each of the first and second liquid crystal display panels being the above liquid crystal display panel, wherein the first and second liquid crystal display panels are disposed so that a first side face and a second side face adjoin each other, the first side face being a side face of the first liquid crystal display panel along which the liquid crystal layer extends, and the second side face being a side face of the second liquid crystal display panel along which the liquid crystal layer extends.

In one embodiment, the above electronic device is foldable around an axis which is a boundary between the first side face and the second side face.

A production method for a liquid crystal display panel according to an embodiment of the present invention comprises: (A) a step of providing a first substrate having a plurality of pixel electrodes and a connection region formed outside the plurality of pixel electrodes; (B) a step of forming a sealing portion surrounding the plurality of pixel electrodes, the sealing portion including a portion located between the connection region and a pixel electrode that is located at an outermost edge among the plurality of pixel electrodes while being adjacent to the connection region; (C) a step of forming a liquid crystal layer having a plurality of liquid crystal regions containing a nematic liquid crystal material and polymer-containing wall between adjacent ones the plurality of liquid crystal regions; and (D) a step of cutting off any portion of the sealing portion excluding a portion thereof.

### Advantageous Effects of Invention

According to an embodiment of the present invention, there is provided a liquid crystal display panel which is suitable for a narrowed frame region and which has a good mass production efficiency.

### BRIEF DESCRIPTION OF DRAWINGS

FIG. 1 (a) is a schematic plan view of a liquid crystal display panel 100A according to an embodiment of the present invention; (b) is a schematic cross-sectional view of the liquid crystal display panel 100A along line I-I′ in FIG. 1(a); and (c) is a schematic cross-sectional view for describing a liquid crystal layer 1 of the liquid crystal display panel 100A.

FIG. 2 An enlarged view of region A in FIG. 1(a).

FIG. 3 (a) is a schematic cross-sectional view for describing a liquid crystal display panel 100B according to another embodiment of the present invention; and (b) is a schematic plan view for describing the liquid crystal display panel 100B.

FIG. 4 (a) is a schematic cross-sectional view for describing a liquid crystal display panel 100C according to still another embodiment of the present invention; and (b) is a schematic plan view for describing the liquid crystal display panel 100C.

FIG. 5 (a) is a schematic plan view of a liquid crystal display panel 100D according to still another embodiment of the present invention; and (b) is a schematic cross-sectional view of the liquid crystal display panel 100D along line II-II′ in (a).

FIG. 6 A schematic plan view for describing a modification of the liquid crystal display panel 100D.

FIGS. 7 (a) and (b) are schematic perspective views for describing an electronic device 200.

FIGS. 8 (a) and (b) are schematic perspective views for describing a production method of the liquid crystal display panel 100A; and (c) is a schematic cross-sectional view along line III-III′ in (b).

FIGS. 9 (a) and (c) are schematic perspective views for describing a production method of the liquid crystal display panel 100A; (b) is a schematic cross-sectional view for describing the production method of the liquid crystal display panel 100A, taken along line IV-IV′ in (a); and (d) is a schematic cross-sectional view for describing the production method of the liquid crystal display panel 100A, taken along line V-V′ in (c).

FIGS. 10 (a) and (b) are schematic perspective views for describing a modification of the production method of the liquid crystal display panel 100A.

FIGS. 11 (a) and (c) are schematic perspective views for describing a production method of the liquid crystal display panel 100D; (b) is a schematic cross-sectional view along line VI-VI′ in (a); and (d) is a schematic cross-sectional view along line VII-VII′ in (c).

FIG. 12 (a) is a schematic plan view of a conventional liquid crystal display panel 500; and (b) is a schematic cross-sectional view of a portion shown at a in (a).

### DESCRIPTION OF EMBODIMENTS

Hereinafter, with reference to the drawings, liquid crystal display panels according to embodiments of the present invention will be described. However, the present invention is not limited to the following embodiments.

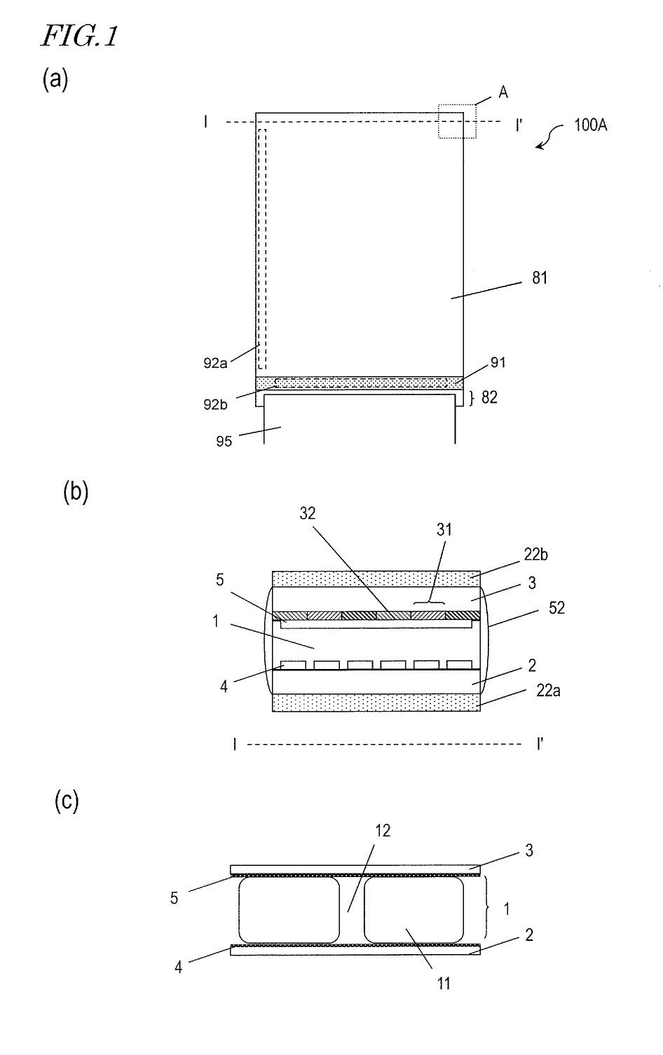

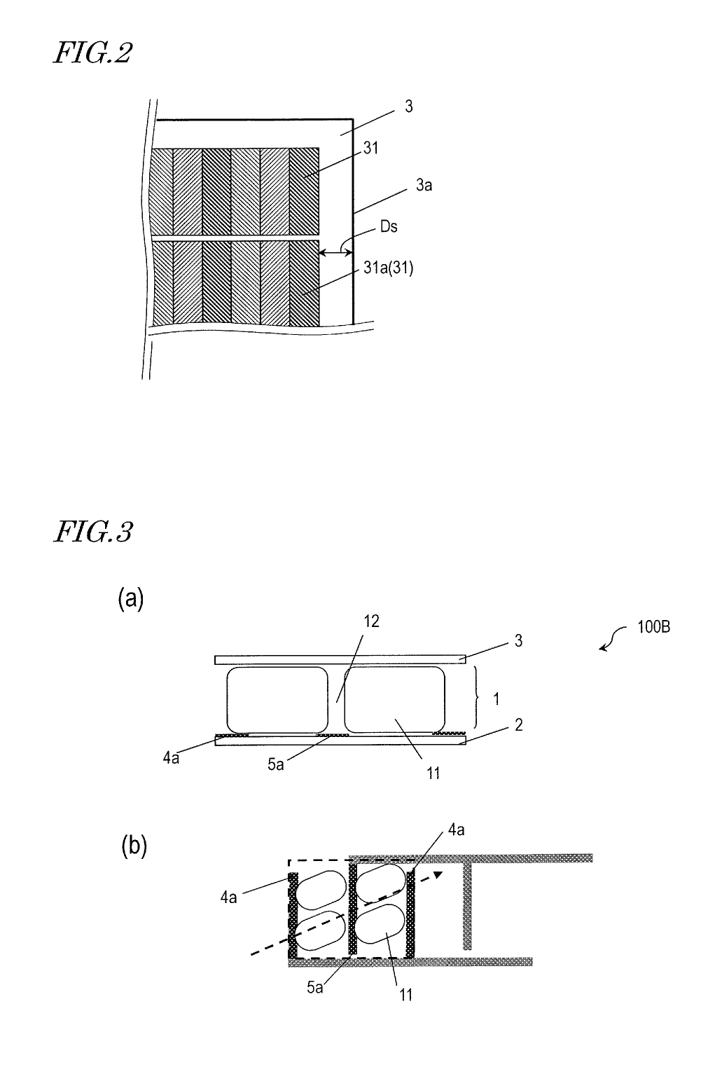

With reference to FIG. 1 and FIG. 2, a liquid crystal display panel 100A according to an embodiment of the present invention is described. FIG. 1(a) shows a schematic plan view of the liquid crystal display panel 100A, and FIG. 1(b) shows a schematic cross-sectional view of the liquid crystal display panel 100A along line I-I′ in FIG. 1(a). FIG. 1(c) is a schematic cross-sectional view showing enlarged a part of the liquid crystal layer 1 shown in FIG. 1(b). FIG. 2 is an enlarged schematic plan view showing region A in FIG. 1(a).

As shown in FIG. 1(a), FIG. 1(b), and FIG. 1(c), the liquid crystal display panel 100A has a displaying region 81 in which a plurality of pixel regions 31 are included. Note that a pixel region 31 is the smallest unit region that composes each primary color (e.g., blue, green, or red). Furthermore, the liquid crystal display panel 100A includes a liquid crystal layer 1 having a plurality of liquid crystal regions 11 containing a nematic liquid crystal material and polymer-containing walls 12 between adjacent ones of the plurality of liquid crystal regions 11. Furthermore, the liquid crystal display panel 100A includes a first substrate 2 and a second substrate 3, the first substrate 2 and the second substrate 3 being disposed so as to retain the liquid crystal layer 1 therebetween. The liquid crystal layer 1 extends to at least one of the side faces of the liquid crystal display panel 100A. In other words, when viewed from the normal direction of the displaying region 81 of the liquid crystal display panel 100A, at least one or more of the side faces of the liquid crystal layer 1 are level with a side face of the first substrate 2 and a side face of the second substrate 3. Moreover, the polymer-containing walls 12 contribute to adhesive bonding of the first substrate 2 and the second substrate 3. Furthermore, as shown in FIG. 2, the sealing portion 91 does not need to be formed in a manner of surrounding the liquid crystal layer 1 in the liquid crystal display panel 100A; therefore, the pixel regions 31 can be formed to near at least one of the side faces of the liquid crystal display panel 100A. Therefore, in the liquid crystal display panel 100A, the width of the frame region not contributing to displaying can be reduced. Specifically, it is preferable that the distance Ds between at least one side face 3a of the second substrate 3 and a pixel region 31a that is located at the outermost edge among the plurality of pixel regions 31 while being adjacent to the at least one side face 3a is 0.2 mm or less. Although the details will be described later, the liquid crystal display panel 100A having such a construction is suitable for a narrowed frame region, and is produced by a production method with a good mass production efficiency.

The liquid crystal display panel 100A includes at least one alignment film (not shown) formed on the first substrate 2 and the second substrate 3 so as to be in contact with the liquid crystal layer 1. The liquid crystal display panel 100A includes: a first horizontal alignment film (e.g., product No. PLX1400 manufactured by HD MicroSystems, Ltd.) which is formed on the first substrate 2 so as to be in contact with the liquid crystal layer 1; and a second horizontal alignment film which is formed on the second substrate 3 so as to be in contact with the liquid crystal layer 1. The first horizontal alignment film and the second horizontal alignment film have each been subjected to an alignment treatment (e.g., a rubbing treatment). Furthermore, they are subjected to alignment treatments such that the direction of the alignment treatment performed for the first horizontal alignment film is orthogonal to the direction of the alignment treatment performed for the second horizontal alignment film. In other words, the liquid crystal display panel 100A includes two liquid crystal regions such that an azimuth of tilt of liquid crystal molecules at the interface with the first alignment film differs from an azimuth of tilt of liquid crystal molecules at the interface with the second alignment film. The liquid crystal display panel 100A is a TN (Twisted Nematic) type liquid crystal display panel. The liquid crystal display panel 100A includes polarizers 22a and 22b provided on sides of the first substrate 2 and the second substrate 3 respectively opposite from the liquid crystal layer 1. A liquid crystal display panel having such a construction is disclosed in International Publication No. 2010/044246. Moreover, the liquid crystal display panel 100A may be modified into a liquid crystal display panel each of whose alignment film is not subjected to an alignment treatment but in which λ/4 plates are provided each between the polarizer 22a and the first substrate 2 and between the polarizer 22b and the second substrate 3. The λ/4 plate and the polarizer 22a or 22b each function as a circular polarizer. A liquid crystal display panel having such a construction is disclosed in International Publication No. 2009/069249.

The liquid crystal display panel 100A includes pixel electrodes 4 formed on the first substrate 2, a color filter layer 32 formed on the second substrate 3, and a common electrode 5 formed on the color filter layer 32. Note that the outer edge of the displaying region 81 is defined by those of the plurality of pixel electrodes 4 which are located at the outermost edge. It is preferable that the common electrode 5 is formed substantially across the entire surface of the displaying region 81, and not outside the displaying region 81. If the common electrode 5 is formed outside the displaying region 81, short-circuiting with an electrode formed on the first substrate 2 may occur, for example. The liquid crystal display panel 100A includes a side-face sealing resin 52 which is formed so as to be in contact with side faces of the liquid crystal layer 1, side faces of the first substrate 2, and side faces of the second substrate 3. The side-face sealing resin 52 enhances the mechanical strength of the liquid crystal display panel 100A, and restrains moisture and the like from intruding into the liquid crystal layer 1, whereby reliability is enhanced. The effect of narrowing the frame region can be obtained without providing the side-face sealing resin 52. However, from the standpoint of improving the reliability of the liquid crystal display panel 100A, it is preferable to provide the side-face sealing resin 52. The side-face sealing resin 52 is made of a photocurable resin (e.g., SEKISUI CHEMICAL CO., LTD., trade name: Photolec A-780), for example.

On the first substrate 2, a thin film transistor (p-Si TFT)(not shown) having e.g. a low-temperature polysilicon semiconductor layer is formed for each pixel, and driving circuits 92a and 92b which are electrically connected to the p-Si TFTs are formed. The driving circuits 92a and 92b are each formed outside the displaying region 81. Furthermore, at a connection region 82, the driving circuit 92b is connected to an external circuit via an FPC (Flexible Printed Circuits) 95, for example. Other than an FPC, the driving circuit 92b may be connected to an external circuit by way of an LSI (Large Scale Integration) driver, TAB (Tape Automated Bonding), or COF (Chip On Film).

Between the displaying region 81 and the connection region 82, a sealing portion 91 is formed for attaching together the first substrate 2 and the second substrate 3. The sealing portion 91 is made of a photocurable resin (e.g., SEKISUI CHEMICAL CO., LTD., trade name: Photolec S-WB), for example. Forming the sealing portion 91 makes it possible to prevent the liquid crystal layer 1 from entering into the connection region 82 during production of the liquid crystal display panel 100A, thus preventing the liquid crystal material from leaking into the connection region 82. The width of the sealing portion 91 is about 1 mm, for example. Note that, if the liquid crystal material or the polymer material leaks into the connection region 82 and contaminates the connection region 82, insufficiencies in the mounting of the FPC 95 or the like may occur. Depending on the degree of contamination, it may not be improved even by providing a separate cleaning step; therefore, it is preferable to form the sealing portion 91 in order to factor in the production yield and production cost at mass production.

As described above, the liquid crystal display panel 100A includes the polarizer 22a disposed on the opposite side of the first substrate 2 from the liquid crystal layer 1 and the polarizer 22b disposed on the opposite side of the second substrate 3 from the liquid crystal layer 1. The polarizer 22a is preferably disposed so that the transmission axis of the polarizer 22a is parallel to the direction of the alignment treatment which has been performed for the alignment film formed on the first substrate 2, and the polarizer 22b is preferably disposed so that the transmission axis of the polarizer 22b is parallel to the direction of the alignment treatment which has been performed for the alignment film formed on the second substrate 3.

Next, with reference to FIG. 3, a liquid crystal display panel 100B according to another embodiment of the present invention will be described. Component elements which are identical to those in the liquid crystal display panel 100A will be denoted by like reference numerals, and their descriptions will not be repeated. FIG. 3(a) is a schematic cross-sectional view for describing the liquid crystal display panel 100B, and FIG. 3(b) is a schematic plan view of the liquid crystal display panel 100B. Note that the liquid crystal display panel 100B and the liquid crystal display panel 100C described below differ from the liquid crystal display panel 100A in terms of display modes.

The liquid crystal display panel 100B shown in FIG. 3(a) and FIG. 3(b) includes a pair of interdigitated electrodes 4a and 5a, instead of the pixel electrodes 4 and the common electrode 5 of the liquid crystal display panel 100A. The pair of interdigitated electrodes 4a and 5a are formed both on the first substrate 2. Similarly to the liquid crystal display panel 100A, the liquid crystal display panel 100B also includes a first horizontal alignment film formed on the first substrate 2 and a second horizontal alignment film formed on the second substrate 3. However, unlike in the liquid crystal display panel 100A, the horizontal alignment films in the liquid crystal display panel 100B are subjected to alignment treatments such that the directions of the alignment treatments performed for the respective horizontal alignment films are antiparallel. The liquid crystal display panel 100B controls the alignment state of the nematic liquid crystal material in the liquid crystal layer 1 with a lateral electric field. As such, the liquid crystal display panel 100B is called a liquid crystal display panel of an IPS (In Plane Switching) driving mode. A liquid crystal display panel of an IPS driving mode is disclosed in Japanese Laid-Open Patent Publication No. 8-313938, for example. Instead of forming a horizontal alignment film on each of the first substrate 2 and the second substrate 3, a vertical alignment film may be formed on each of the first substrate 2 and the second substrate 3.

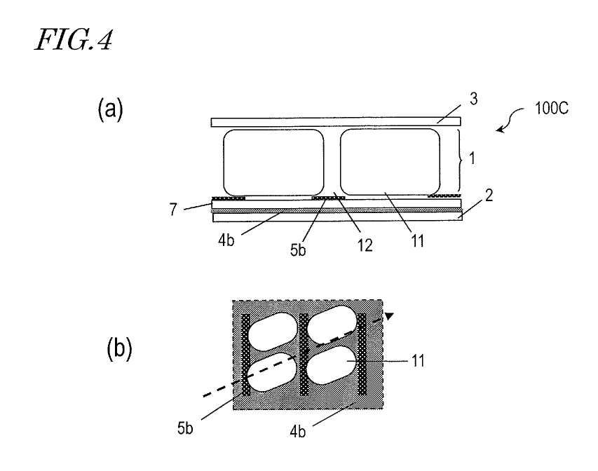

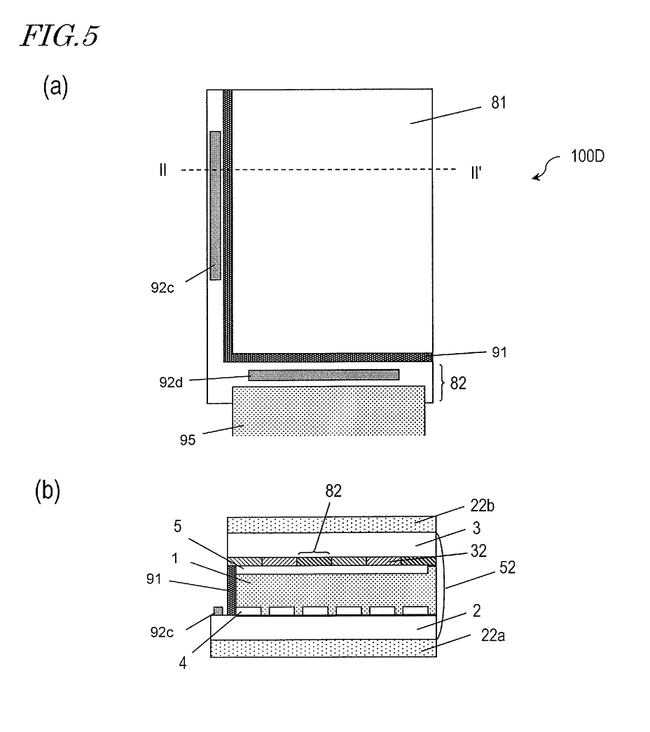

Next, with reference to FIG. 4, a liquid crystal display panel 100C according to another embodiment of the present invention will be described. Component elements which are identical to those in the liquid crystal display panel 100A will be denoted by like reference numerals, and their descriptions will not be repeated. FIG. 4(a) is a schematic cross-sectional view for describing the liquid crystal display panel 100C, and FIG. 4(b) is a schematic plan view for describing the liquid crystal display panel 100C.

Instead of forming the pair of interdigitated electrodes 4a and 5a of the liquid crystal display panel 100B, the liquid crystal display panel 100C shown in FIG. 4(a) and FIG. 4(b) includes a lower electrode 4b which is formed across the entire displaying region 31 of the first substrate 2, an insulating layer 7 formed on the lower electrode 4b, and interdigitated electrodes 5b formed on the insulating layer 7. Similarly to the liquid crystal display panel 100B, the liquid crystal display panel 100C controls the alignment state of the nematic liquid crystal material of the liquid crystal layer 1 with a lateral electric field. As such, the liquid crystal display panel 100C is called a liquid crystal display panel of an FFS (Fringe Field Switching) driving mode. In the liquid crystal display panel 100C, instead of a horizontal alignment film formed on each of the first substrate 2 and the second substrate 3, a vertical alignment film may be formed on each of the first substrate 2 and the second substrate 3.

Next, with reference to FIG. 5, a liquid crystal display panel 100D according to another embodiment of the present invention will be described. Component elements which are identical to those in the liquid crystal display panel 100A will be denoted by like reference numerals, and their descriptions will not be repeated. FIG. 5(a) is a schematic plan view for describing the liquid crystal display panel 100D, and FIG. 5(b) is a schematic cross-sectional view along line II-II′ in FIG. 5(a).

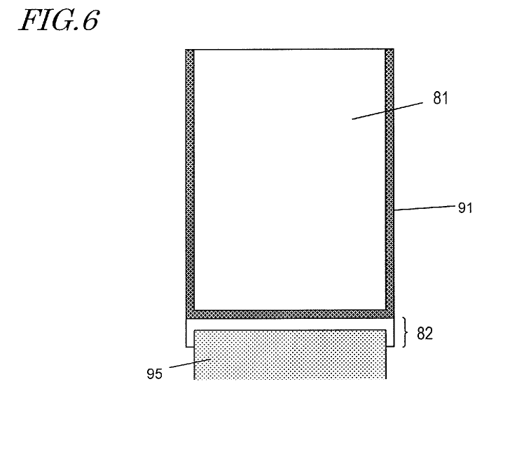

The liquid crystal display panel 100D is a liquid crystal display panel including thin film transistors (a-Si TFTs) having an amorphous silicon semiconductor layer, instead of the p-Si TFTs of the liquid crystal display panel 100A. The a-Si TFTs are formed on the first substrate 2 correspondingly to respective pixels. Furthermore, in the liquid crystal display panel 100D, driving circuits 92c and 92d for driving the a-Si TFTs are mounted outside the displaying region 81. The driving circuit 92d is connected to an external circuit at a connection region 82 which is electrically connected to an external circuit, via an FPC 95, for example. Other than an FPC, the driving circuit 92d may be connected to an external circuit by way of an LSI driver, TAB, or COF. The liquid crystal display panel 100D includes sealing portions 91 respectively between the displaying region 81 and the driving circuits 92c and 92d. Forming the sealing portions 91 in this manner makes it possible to prevent the liquid crystal layer 1 from extending into the regions in which the driving circuits 92c and 92d are mounted, when forming the liquid crystal display panel 100D. Moreover, as shown in FIG. 6, depending on the purpose of use of the liquid crystal display panel 100D, the construction may be modified into one where the sealing portions 91 are formed in a U-shape.

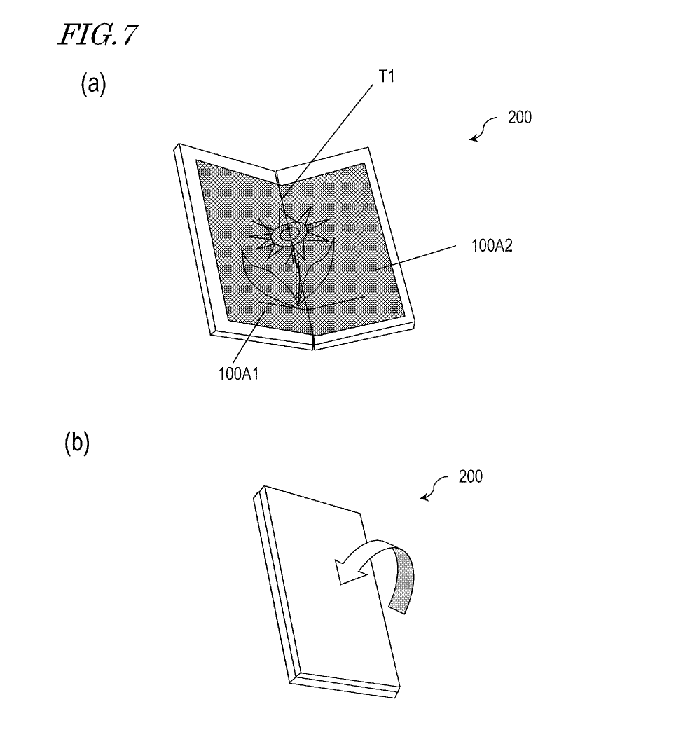

For example, the aforementioned liquid crystal display panels 100A to 100D may be combined to produce a large-sized display panel. Otherwise, as shown in FIG. 7(a) and FIG. 7(b), the aforementioned liquid crystal display panels 100A to 100D are applicable to an electronic device 200 which can be laid open like a book. The electronic device 200 includes a first liquid crystal display panel 100A1 and a second liquid crystal display panel 100A2 having the same construction as the liquid crystal display panel 100A, for example. The liquid crystal display panels 100A1 and 100A2 of the electronic device 200 are disposed so that a first side face, which is a side face of the one liquid crystal display panel 100A1 along which the liquid crystal layer 1 extends, and a second side face, which is a side face of the other liquid crystal display panel 100A2 along which the liquid crystal layer 1 extends, adjoin each other. In the electronic device 200 as such, the arrangement of the liquid crystal display panels 100A1 and 100A2 achieves continuous displaying as if a single liquid crystal display panel. Moreover, when it is made foldable around an axis which is the boundary T1 between the first side face and the second side face, the electronic device 200 can attain a large display screen size while retaining excellent portability.

Next, a production method of the liquid crystal display panel 100A will be described.

The production method of the liquid crystal display panel 100A according to an embodiment of the present invention includes: (A) a step of providing a first substrate 2 having a plurality of pixel electrodes 4 and a connection region 82 formed outside the plurality of pixel electrodes 4; (B) a step of forming a sealing portion 91 so as to surround the plurality of pixel electrodes 4, a portion of the sealing portion 91 being formed in between the connection region 81 and a pixel electrode 4 among the plurality of pixel electrodes 4 that is located at the outermost edge while being adjacent to the connection region 82; (C) a step of forming a liquid crystal layer 1 including a plurality of liquid crystal regions 11 containing a nematic liquid crystal material and polymer-containing walls 12 between adjacent ones of the plurality of liquid crystal regions 11; and (D) a step of cutting off the sealing portion 91 except for a portion thereof. The liquid crystal display panel 100A is produced by such a method.

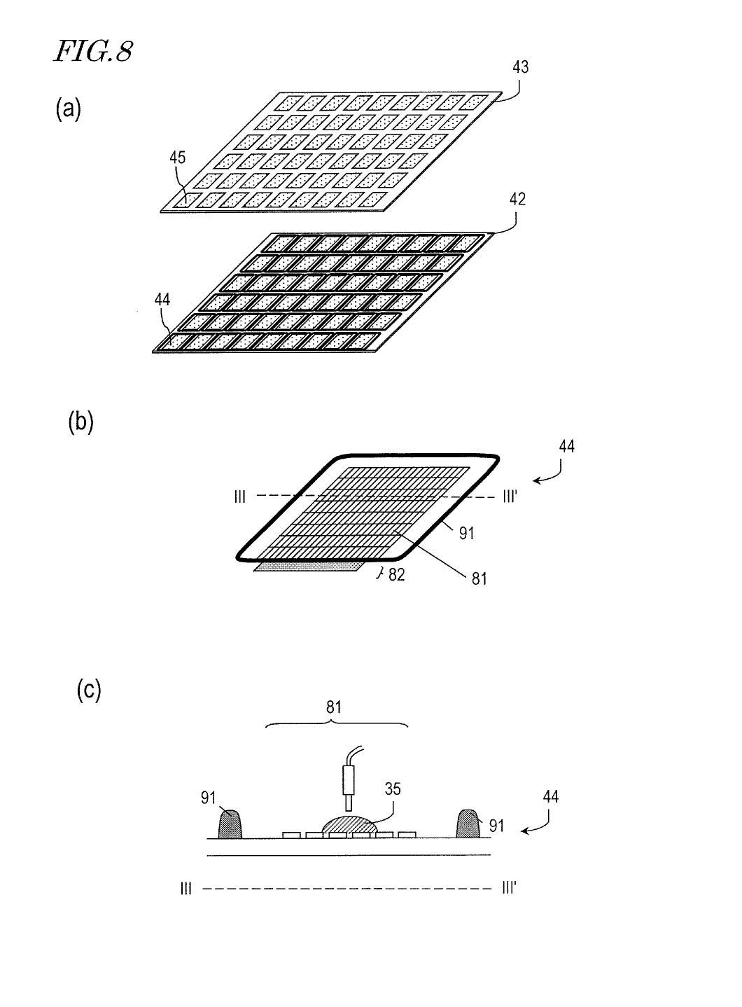

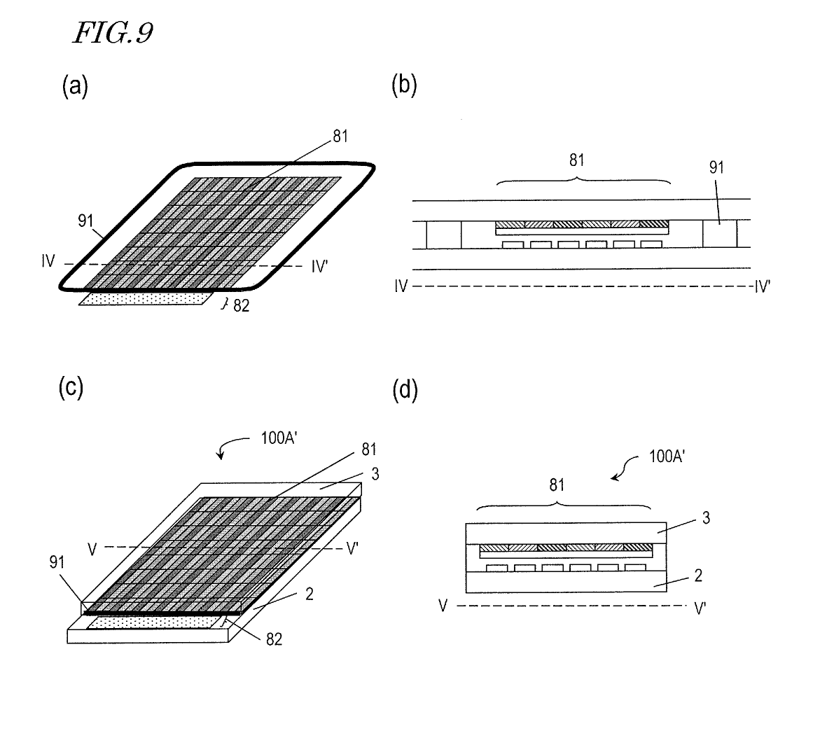

Next, with reference to FIG. 8 and FIG. 9, the production method of the liquid crystal display panel 100A according to an embodiment of the present invention will be specifically described. FIG. 8(a) and FIG. 8(b) are schematic perspective views for describing the production method of the liquid crystal display panel 100A. FIG. 8(c) is a schematic cross-sectional view along line III-III′ in FIG. 8(b). FIG. 9(a) and FIG. 9(c) are schematic perspective views for describing the production method of the liquid crystal display panel 100A. FIG. 9(b) is a schematic cross-sectional view along line IV-IV′ in FIG. 9(a), and FIG. 9(d) is a schematic cross-sectional view along line V-V′ in FIG. 9(b).

As shown in FIG. 8(a), a first mother substrate 42 and a second mother substrate 43 are provided. A plurality of TFT substrates 44 are formed in the first mother substrate 42. On each of the plurality of TFT substrates 44, for example, a p-Si TFT is formed for each pixel by a known method, and a horizontal alignment film is formed substantially across the entire TFT substrate 44 by a known method. In the second mother substrate 43, a plurality of color filter substrates 45 having a color filter layer are formed by a known method, and a horizontal alignment film is formed substantially across the entire color filter substrate 45 by a known method.

Next, as shown in FIG. 8(b), a sealant (e.g., UV-curing resin) 91 (the same reference numeral as the sealing portion 91 is given for simplicity) is applied onto each TFT substrate 44 by a known method. The sealant 91 is applied so as to surround the displaying region 81. At this time, a portion of the sealant 91 is formed between the displaying region 81 and the connection region 82, whereas other portions are formed away from the displaying region 81 (so as to be apart by e.g. 0.2 mm or more).

Next, as shown in FIG. 8(c), a liquid mixture 35 in which a nematic liquid crystal material and a monomer are mixed is applied dropwise in a region surrounded by the sealant 91 by an ODF (One Drop Fill) technique. At this time, the mass ratio between the nematic liquid crystal material and the monomer is 80:20 (nematic liquid crystal material: monomer=80:20). The mass ratio is not limited thereto, and a liquid mixture 35 whose monomer concentration is not less than 10 mass % and not more than 30 mass % may be used. The walls 12 of polymer that have been formed from the monomer are regions not contributing to displaying. Therefore, when the monomer concentration is less than 10 mass %, the transmittance of the liquid crystal display panel 100A, i.e., luminance of displaying, increases, but the mechanical strength of the liquid crystal display panel 100A is deteriorated. When the monomer concentration is more than 30 mass %, the liquid crystal display panel 100A has a high mechanical strength, but the transmittance of the liquid crystal display panel 100A, i.e., luminance of displaying, decreases. Moreover, since the sealant 91 is applied so as to surround the displaying region 81, the liquid mixture 35 having been applied dropwise will not leak out of the sealing portion 91.

Next, as shown in FIG. 9(a) and FIG. 9(b), after the first mother substrate 42 and the second mother substrate 43 are attached together by a known method, the monomer within the sealant 91 and the displaying region 81 is irradiated with ultraviolet, thus curing them. As a result, the sealing portion 91 and the liquid crystal layer 1 including the polymer-containing walls 12 and the liquid crystal regions 11 are obtained. The cumulative light amount for cure the sealant 91 and the monomer is about 1 to 4 J/cm² for light of a wavelength of 365 nm, although it depends on the material.

Next, as shown in FIG. 9(c) and FIG. 9(d), the mother panel composed of the first mother substrate 42 and the second mother substrate 43 attached together is cut into each liquid crystal display panel 100A′ by a known method. At this time, the portions of the sealing portion 91 other than the portion formed between the displaying region 81 and the connection region 82 are cut off through the cutting. As shown in FIG. 2, the cutting is preferably performed in such a manner that the distance Ds between at least one of the side faces of the second substrate 3 of the liquid crystal display panel 100A′ having been cut and a pixel region 82a that is located at the outermost edge among the plurality of pixel regions 31 while being adjacent to the at least one side face is less than 0.2 mm. The human eye is said to have a resolving power of 0.2 mm. When the distance Ds is less than 0.2 mm, the human eye will not recognize the frame region, as if the frame region did not exist. Since the liquid crystal layer 1 has the liquid crystal regions 11 that are partitioned by the polymer-containing walls 12, even if a wall 12 that is located between adjacent liquid crystal regions 11 of the liquid crystal layer 1 is partly destroyed through cutting, only the liquid crystal material in the liquid crystal regions 11 that are in contact with the destroyed wall 12 will leak out, rather than all the liquid crystal material within the liquid crystal layer 1 leaking out; thus, this does not present problems in displaying.

Next, as shown in FIG. 1(b), those side faces of the liquid crystal display panel 100A′ excluding the side faces along which the sealing portion 91 is formed are sealed with the side-face sealing resin 52. The side-face sealing resin 52 is made of a UV-curing resin, for example. Thereafter, polarizers 22a and 22b are placed on the sides of the first substrate 2 and the second substrate 3 of the liquid crystal display panel 100A′ respectively opposite from the liquid crystal layer 1. Other than the polarizers 22a and 22b, optical compensation films or the like may be placed on the sides of the first substrate 2 and the second substrate 3 opposite from the liquid crystal layer 1.

The above production method is illustrated as a production method of a liquid crystal display panel in which the liquid mixture 35 is applied dropwise by ODF technique. In the case where the liquid crystal display panel is produced by injecting the liquid mixture 35 with a vacuum injection technique, the above production method can be modified as follows.

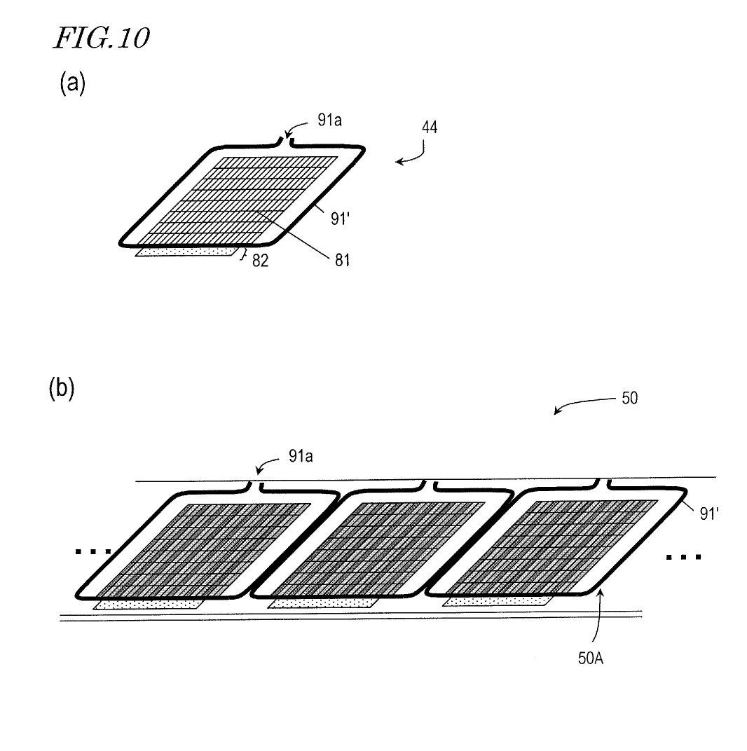

FIG. 10(a) and FIG. 10(b) are schematic perspective views for describing a modification of the production method of the liquid crystal display panel 100A.

First, as described above, the first mother substrate 42 and the second mother substrate 43 are provided.

Next, as shown in FIG. 10(a), a sealant (e.g., thermosetting resin) 91′ is applied onto each TFT substrate 44 by a known method. The sealant 91′ is applied so as to surround the displaying region 81. At this time, a portion of the sealant 91′ is applied between the displaying region 81 and the connection region 82, whereas other portions are applied away from the displaying region 81 (so as to be apart by e.g. 0.2 mm or more). Moreover, the sealant 91′ is applied so as to leave an injection inlet 91a, through which the liquid mixture 35 of the liquid crystal material and the monomer is to be injected.

Next, as described above, the first mother substrate 42 and the second mother substrate 43 are attached together by a known method, and the sealant 91′ is cured by a known method to form a sealing portion 91′ (the same reference numeral as the sealant 91′ is given for simplicity).

Next, as shown in FIG. 10(b), the mother panel composed of the first mother substrate 42 and the second mother substrate 43 attached together is cut into strip shapes by a known method, thus producing a sub-mother cell 50.

Next, the aforementioned liquid mixture 35 of the liquid crystal material and the monomer is injected into each liquid crystal cell 50A by a vacuum injection technique. After injecting the liquid mixture 35, the injection inlet 91a is sealed with a UV-curing resin. Thereafter, through ultraviolet irradiation, the monomer in the liquid mixture 35 is cured.

Next, the strip-shaped sub-mother cell 50 is cut into respective liquid crystal display panels. Thereafter, the side-face sealing resin 52 is formed, and the polarizers 22a and 22b, etc., are placed, whereby the liquid crystal display panel 100A is produced (see FIG. 1(b)).

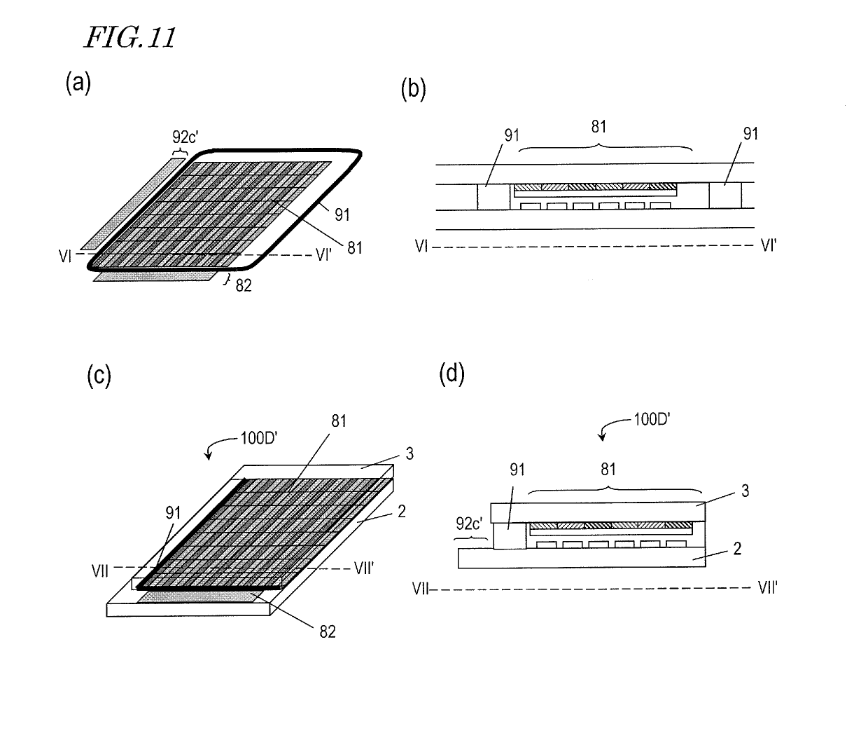

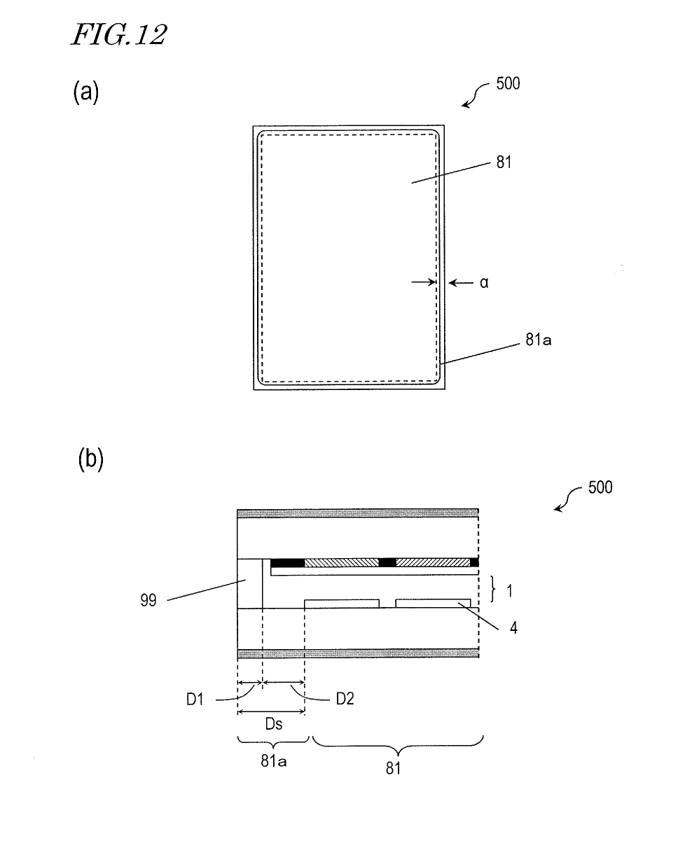

Next, with reference to FIG. 11, a production method of the liquid crystal display panel 100D according to another embodiment of the present invention will be described. The method described below is a method of producing the liquid crystal display panel 100D by applying dropwise the aforementioned liquid mixture 35 of the liquid crystal material and the monomer by ODF technique. FIG. 11(a) and FIG. 11(c) are schematic perspective views for describing the production method of the liquid crystal display panel 100D. FIG. 11(b) is a schematic cross-sectional view along line VI-VI′ in FIG. 11(a), and FIG. 11(d) is a schematic cross-sectional view along line VII-VII′ in FIG. 11(c).

As described above, the first mother substrate 42 and the second mother substrate 43 are provided.

Next, as shown in FIG. 11(a) and FIG. 11(b), a sealant (e.g., UV-curing resin) 91 is applied onto each TFT substrate 44 by a known method. The sealing portion 91 is applied so as to surround the displaying region 81. At this time, a portion of the sealant 91 is applied between the displaying region 81 and the connection region 82 and between a region 92c′ in which a driving circuit 92c is to be mounted and the displaying region 81, whereas other portions are applied away from the displaying region 81 (so as to be apart by e.g. 0.2 mm or more).

Next, as described above, the liquid mixture 35 in which a nematic liquid crystal material and a monomer are mixed is applied dropwise in a region surrounded by the sealant 91 by ODF technique.

Next, after the first mother substrate 42 and the second mother substrate 43 are attached together by a known method, the sealant 91 and the monomer are irradiated with ultraviolet, thus curing them.

Next, as shown in FIG. 11(c) and FIG. 11(d), the mother panel composed of the first mother substrate 42 and the second mother substrate 43 attached together is cut into respective liquid crystal display panels 100D′ by a known method. At this time, the portion excluding the portion of the sealing portion 91 formed between the displaying region 81 and the connection region 82, and excluding the portion of the sealing portion 91 formed between the connection region 92c′ in which the driving circuit 92c is to be mounted and the displaying region 81, is cut off through the cutting.

Next, those side faces of the liquid crystal display panel 100D′ excluding the side faces along which the sealing portion 91 is formed are sealed with the side-face sealing resin 52. For example, a UV-curing resin is used as the side-face sealing resin 52. Thereafter, polarizers 22a and 22b are placed on the sides of the first substrate 2 and the second substrate 3 of the liquid crystal display panel 100D′ respectively opposite from the liquid crystal layer. Other than the polarizers 22a and 22b, optical compensation films or the like may be placed on the sides of the first substrate 2 and the second substrate 3 opposite from the liquid crystal layer (see FIG. 5(b)).

The liquid crystal display panel 100D is produced in the above manner.

Thus, with the liquid crystal display panels 100A to 100D according to embodiments of the present invention, there is provided a liquid crystal display panel which is suitable for a narrowed frame region and which has a good mass production efficiency.

### INDUSTRIAL APPLICABILITY

According to an embodiment of the present invention, there is provided a liquid crystal display panel which is suitable for a narrowed frame region. In particular, such a liquid crystal display panel is suitably used for a medium to small-sized device such as an electronic book, a mobile phone, or a smartphone, for example.

### REFERENCE SIGNS LIST

1 liquid crystal layer
2, 3 substrate
4 pixel electrode
5 common electrode
11 liquid crystal region
12 wall
22a, 22b polarizer
32 color filter layer
52 side-face sealing resin
81 displaying region
82 connection region
100A liquid crystal display panel

1. A liquid crystal display panel having a displaying region including a plurality of pixel regions, the liquid crystal display panel comprising:
a liquid crystal layer having a plurality of liquid crystal regions containing a nematic liquid crystal material and polymer-containing walls between adjacent ones of the plurality of liquid crystal regions; and
a first substrate and a second substrate having the liquid crystal layer retained therebetween, wherein,
the liquid crystal layer extends to at least one side face of the liquid crystal display panel; and
a distance between at least one side face of the second substrate and a pixel region that is located at an outermost edge among the plurality of pixel regions while being adjacent to the at least one side face is less than 0.2 mm.

2. The liquid crystal display panel of claim 1, further comprising:
a first alignment film and a second alignment film respectively formed between the liquid crystal layer and the first substrate and the second substrate so as to be each in contact with the liquid crystal layer; and
polarizers respectively provided on sides of the first substrate and the second substrate opposite from the liquid crystal layer.

3. The liquid crystal display panel of claim 2, wherein,
the nematic liquid crystal material has positive dielectric anisotropy;
at least one of the first alignment film and the second alignment film is a horizontal alignment film;
the horizontal alignment film has been subjected to an alignment treatment; and
in the plurality of liquid crystal regions, in the absence of applied voltage, an in-plane azimuth of liquid crystal molecules at an interface with the horizontal alignment film which has been subjected to an alignment treatment is parallel to an azimuth defined by the alignment treatment.

4. The liquid crystal display panel of claim 2, wherein,
the nematic liquid crystal material has positive dielectric anisotropy; and
the first alignment film and the second alignment film are vertical alignment films.

5. The liquid crystal display panel of claim 2, wherein an alignment state of the nematic liquid crystal material is controlled with a lateral electric field.

6. The liquid crystal display panel of claim 3 including two liquid crystal regions such that, in the absence of applied voltage, an azimuth of tilt of liquid crystal molecules at an interface with the first alignment film differs from an azimuth of tilt of liquid crystal molecules at an interface with the second alignment film.

7. The liquid crystal display panel of claim 1, further comprising λ/4 plates provided between the first substrate and the polarizer and between the second substrate and the polarizer.

8. The liquid crystal display panel of claim 1, having a connection region to be electrically connected to an external circuit, and
having a sealing portion that adhesively bonds the first substrate and the second substrate, the sealing portion being between the connection region and the displaying region.

9. The liquid crystal display panel of claim 8,
having a driving circuit provided outside the displaying region, and
having the sealing portion between the driving circuit and the displaying region.

10. The liquid crystal display panel of claim 1, wherein, when viewed from a normal direction of the liquid crystal display panel, at least one or more of side faces of the liquid crystal layer are level with a side face of the first substrate and a side face of the second substrate.

11. The liquid crystal display panel of claim 10, further comprising a side-face sealing resin portion formed so as to be in contact with the side face of the liquid crystal layer and the side face of the first substrate and the side face of the second substrate.

12. An electronic device comprising first and second liquid crystal display panels, each of the first and second liquid crystal display panels being the liquid crystal display panel of claim 1, wherein
the first and second liquid crystal display panels are disposed so that a first side face and a second side face adjoin each other, the first side face being a side face of the first liquid crystal display panel along which the liquid crystal layer extends, and the second side face being a side face of the second liquid crystal display panel along which the liquid crystal layer extends.

13. The electronic device of claim 12 being foldable around an axis which is a boundary between the first side face and the second side face.

14. A production method for a liquid crystal display panel, comprising:
(A) a step of providing a first substrate having a plurality of pixel electrodes and a connection region formed outside the plurality of pixel electrodes;
(B) a step of forming a sealing portion surrounding the plurality of pixel electrodes, the sealing portion including a portion located between the connection region and a pixel electrode that is located at an outermost edge among the plurality of pixel electrodes while being adjacent to the connection region;
(C) a step of forming a liquid crystal layer having a plurality of liquid crystal regions containing a nematic liquid crystal material and polymer-containing wall between adjacent ones the plurality of liquid crystal regions; and
(D) a step of cutting off any portion of the sealing portion excluding a portion thereof.
